(19) United States
(12) Patent Application Publication
(10) Pub. No.: US 2010/0031342 A1
(43) Pub. Date: Feb. 4, 2010

(54) Method and system for providing secure video data transmission and processing

(75) Inventor: Robin O. Vogsland, Rio Rancho, NM (US)

Correspondence Address: HONEYWELL/S&S;Patent Services, 101 Columbia Road, P.O.Box 2245, Morristown, NJ, 07962-2245, US

(73) Assignee: Honeywell International, Inc, Morristown, NJ (US)

(21) Appl. No.: 12/082,450

(22) Filed: Apr. 11, 2008

Related U.S. Application Data
(60) Provisional application No. 60/911,369, filed on Apr. 12, 2007.

(51) Int. Cl. G06F 21/00

(52) U.S. Cl. 726/17

(57) ABSTRACT

A system and method for secure graphics processing employing an operating system that supports multiple independent levels of security (MILS) is described. A video queuing mechanism is provided in conjunction with a cross domain guard to receive extended graphics language video inputs from multiple input applications in multiple security enclaves. Without accessing sensitive data, a function manages desired format and mode selections of the displays, coordinates the execution of multiple graphics applications that produce the needed video content, as well as communicate with a one or more high assurance render functions regarding how to draw each video output's content in a secure and easily certifiable manner.

### CROSS REFERENCE TO RELATED APPLICATION

The present patent application claims priority under 35 U.S.C. §119(e) to U.S. Provisional Patent Application Ser. No. 60/911,369, filed on Apr. 12, 2007, the entire contents of which are incorporated herein by reference as if fully set forth in this description.

### FIELD

The present application relates generally to graphics processing, and more particularly, relates to a graphics processing system that maintains separation of data received from different sources and renders data to one or more video outputs based on a given security authorization.

### BACKGROUND

In secure processing systems, mixing data with different security levels is undesirable. For example, security levels may include unclassified, secret, secret-compartmentalized, top secret, civilian-confidential, and so on. A multi-level secure graphics processing system needs a mechanism to keep inputs from different sources secure and modular. Additionally, the graphics processing system needs a mechanism to render one or more video outputs with different security authorizations.

Existing systems handling classified data typically have separate systems, each including a separate display so that a system only handles one type of data. In this example, a user would need to view one display for unclassified information, and a different display to view classified information. The physical separation of computer resources using multiple systems for classified/unclassified data in parallel with each other maintains separation of the data. However, within an airplane or other area with limited space and limited computer resources, it may not be possible to house multiple systems. Thus, it is desirable to handle multiple types of data within a single system, to allow user workstations access to all data from all authorized sources with natural and modular layering (without redesigning source applications for the particular system), and to maintain separation of the data so as not to allow unauthorized applications or displays to have access to certain types of data.

### SUMMARY

A system and method for secure graphics processing is described. The system and method allows data with multiple independent levels of security (MILS) to be managed in a manner amenable to formal security certification methods.

Recent advances in computer science include the commercial availability of computer operating systems that support software-based separation of data processing for Multiple Independent Levels of Security (MILS). These components enable many MILS applications to be practical to implement on a computing platform and to achieve superior operational and technical characteristics for modularity and reusability. Software-separated MILS systems are composed of two types of software partition, partitions for a single level of security (SLS) and partitions for multiple levels of security (MLS). Each SLS partition supports applications that have one type of security clearance. MLS partitions support applications that handle data with more than one type of security clearance. In addition, partitions can require exchange of data with partitions at different security levels, which is managed by the MILS operating system and by creation of small MLS-qualified applications referred to as (cross-domain) Guards (for data transfer to a more restricted, more classified enclave) and as Downgraders (for data transfer to a less restricted, lower classification, enclave).

An operating system that supports MILS-certification can support memory space partitioning and optionally execution Time partitioning. Time and space partitioning allows a system to meet security certification requirements for use in Multiple Independent-Levels-of-Security (MILS) processing by allocating software with different security specifications to separate partitions and using strictly controlled inter-partition communication ports to regulate data exchange between partitions to meet N.E.A.T objectives: Non-bypassable (security functions cannot be circumvented), Evaluatable (security functions are small enough and simple enough for mathematical verification), Always Invoked (security functions are invoked each and every time), Tamperproof (subversive code cannot alter the security data or functions).

The system of the present application supports multiple graphics applications, each stored and executed in a respective security enclave that includes one or more software partitions. These graphics source applications can operate in a single level of security (SLS) partition and produce one or more video outputs via secure communication channels provided by the MILS operating system. Other graphics source applications can operate in an MLS partition to produce one or more video outputs on separate secure communication channels output provided by the MILS operating system. In addition, the system allows some exchange of data between enclaves with different security levels that may be managed by the MILS operating system that allows highly controlled, one way secure data transmission ports and by creation of small MLS applications, or (cross-domain) Guards and Downgraders. In addition, encryption may be used where data communication is through a link that is not certified to be isolated from other enclaves.

The graphics applications use a predefined graphics language (GL) application programming interface (API) or protocol (such as Open-Graphics Language (OGL)), that directs queued graphical instructions to a graphics language queue and an MLS guard that directs the data to a secure application to merge and render the data in a video stream with the required security classification level. Changing the security level of the graphics rendering channel may be supported by appropriate software or hardware isolation practices. The graphics language API may also be adapted to support one-directional communication.

The present application describes software being divided into multiple partitions with different security attributes added to a Multiple-Independent-Levels-of-Security (MILS) compatible Operating System running on suitable certifiable processor equipment. Supporting hardware may be added in the form of one or more graphics OGL symbology computation devices to produce graphical data for a single security enclave at a time. In addition, a separate MLS partition may serve as a cross-domain guard to receive queued OGL symbology from the various single security level computation partitions or multiple security level computation partitions with multiple independent outputs and direct their outputs to one or more SLS rendering partitions. A guard contains a routing policy engine that ensures that each display channel only has access to data for which it is authorized. The Queue/Guard function transmits (or upgrades) data from multiple SLS or MLS applications (at multiple security levels) to one or more independent SLS streams of combined data to be rendered on each of several displays.

The system and method may be used in military secure processing systems, including aircraft and ground vehicles, as well as commercial systems that process sensitive data, to created mixed content displays while keeping source applications isolated from one another.

Less computation resources can be used because data from any graphics source can be computed once and routed through a guard to the merge and render function of all authorized security enclaves.

By initially structuring applications to separate data into objects or layers, the modularity and flexibility of the system can be enhanced in that the visible overlap of objects from multiple enclaves can appear as though they were created in a single monolithic application without the expense of re-engineering the applications to work together for each variant configuration of the system.

By using MILS principles, the isolation of data to prevent access violations across the multiple security enclaves can be accomplished by structural means (exploiting the MILS RTOS) rather than by writing software logic in the applications and guards that is verified by elaborate means, i.e., unauthorized data is blocked because the data cannot be accessed rather than by examining the data and deciding that the data should be blocked.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

FIG. 1 is a block diagram illustrating an example of a system for providing secure video processing.

FIG. 2 illustrates another embodiment of an example of a system for providing secure video processing.

FIG. 3 is a flowchart including example functional steps for providing secure video processing.

FIG. 4 is a flowchart illustrating example functions performed by a video queue/guard

FIG. 5 is a flowchart illustrating example functions associated with a rendering process for display terminals.

FIG. 6 illustrates an example conceptual diagram showing one example of page list formatting and communicating page display lists between elements of the system.

### DETAILED DESCRIPTION

The present application provides a method and system for receiving data from multiple sources and routing the data to an appropriate graphics engine to compose and display an image based on the data. The system maintains separation of data so as to keep data of one classification separate from data having a different classification.

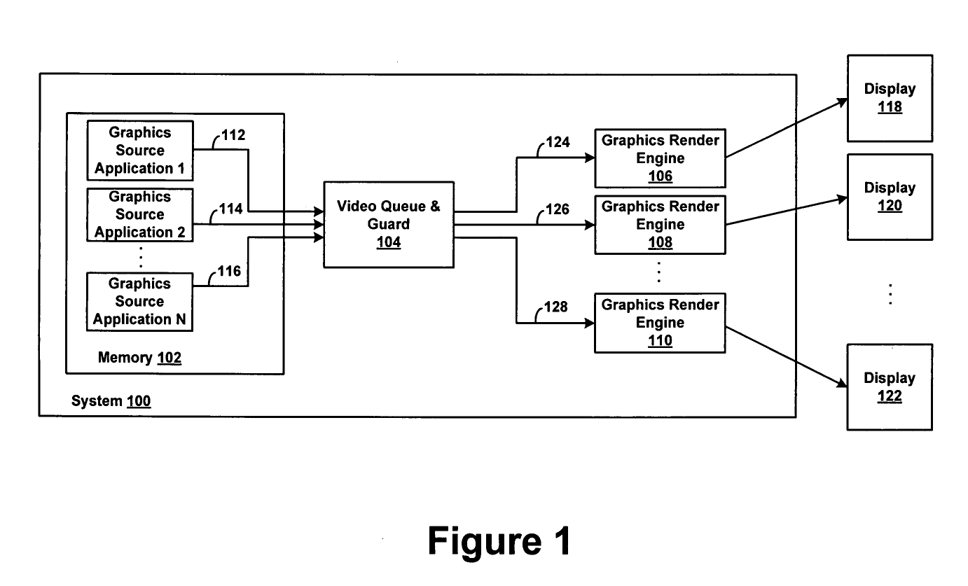

FIG. 1 is a block diagram illustrating a system 100 for providing secure video processing. The system 100 includes memory 102 coupled to a routing policy engine 104. The routing policy engine 104 is coupled to graphics render engines 106, 108 and 110. In other embodiments, the memory 102 may be extended to be used directly by other system functions 104, 106, 108, and 110 or may be subdivided to support any grouping of the graphics source applications and their secure output channels 112, 114, and 116, as well as the video queue and guard 104 or the Graphics Render Engines 106, 108, and 110 within a particular the portion of memory for convenience of implementation.

The system 100 may be in the form of a computer or multiplicity of networked computers generally in the range from a hand-held device, laptop, or personal computer to a larger computer such as a workstation with multiple multiprocessors that is equipped with one or more an operating system that are MILS-certifiable. An illustrative computer may use Pentium™ or Power PC™ or other microprocessors and may operate under a Real-Time Operating System (RTOS) operating system, or yet may use some other microprocessor or non-real-time MILS-certified operating system based on UNIX or other technology.

The system 100 may operate using any suitable graphics language (GL). One example is the Open Graphics Library (OGL) that is a standard specification that defines a cross-language, cross-platform application programming interface (API) for writing applications that do two or three dimensional computer graphics. The interface includes over 250 different function calls, which can be used to draw complex two-dimensional and three-dimensional scenes from simple primitives. OGL was developed by Silicon Graphics Inc. and the Khronos Group currently controls the OGL standard specifications. OGL is widely used in CAD, virtual reality, scientific visualization, information visualization, flight simulation and video game development. The OGL API usually employs feedback from a driver to a source application to communicate current drawing parameter settings. The feedback can be eliminated by defining fixed default states to be used by the applications and driver for various situations. This allows a simple guard (upgrader) to be used for the video streams rather than a more expensive combination of guard and downgrader required for bi-directional data flow. The applications can be structured to divide the data stream into discrete packets or other groupings corresponding to the objects or layers whose draw order may be desirable to control differently in multiple applications.

Although not shown, the system 100 may also include an input device, such as a keyboard, a trackball, and/or a two or three-button mouse, if so desired. One skilled in the art of computer systems will understand that the present example embodiments are not limited to any particular class or model of computer employed for the system 100 and will be able to select an appropriate system.

The memory 102 may include a computer readable medium and optionally a separate computer-readable working memory. The term computer readable medium, as used herein, refers to any medium that participates in providing instructions to a processor unit for execution. Such a medium may take many forms, including but not limited to, non-volatile media and transmission media. Non-volatile media include, for example, optical or magnetic disks, or non-volatile solid state storage devices. Working memory may be volatile or non-volatile media, for example, dynamic memory, such as main memory or random access memory (“RAM”). Common forms of computer readable media include, for example, floppy disks, flexible disks, hard disks, magnetic tape, punch cards, CD-ROM, a RAM, a PROM, an EPROM, a FLASH-EPROM, and any other memory chip or cartridge, or any other medium from which a computer can read.

It should also be noted that the system 100 generally executes application programs resident at the system 100 in the memory 102 under the control of the operating system of the system 100.

Applications stored in the memory 102 may take the form of computer-executable software functions, which may be provided using machine language instructions or software with object-oriented instructions, such as the C++ programming language. However, other programming languages (such as the C or JAVA programming languages for instance) could be used as well. In addition, it will be apparent to those of ordinary skill in the art that the methods described herein may be embodied in a computer program product that includes one or more computer readable media, as described as being present within the system 100. The computer readable medium can also include a communications or transmission medium, such as, a bus, network, or a communication link, either optical, wired or wireless having program code segments carried thereon as digital or analog data signals.

The routing policy engine 104 and the graphic render engines 106, 108 and 110 may take the form of a processor capable of executing instructions for performing methods described herein. As mentioned, a processor may operate according to an operating system, which may be any suitable commercially available embedded or disk-based MILS operating system, or any proprietary MILS operating system. The processor may comprise one or more smaller central processing units, including, for example, a programmable digital signal processing engine or a multi-core processor. The processor may also be implemented entirely or in part as a single application specific integrated circuit (ASIC) to improve speed and to economize space.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

Referring now to the memory 102 of the system 100, the memory 102 includes storage for applications 1 to application N. Each application is stored in a separate partition within the memory 102. Program storage and program execution may be from different memory types, but both types can be in the same enclave and isolated from other enclaves by the operating system, system boot applications, and by memory management units and other features of the computer hardware. Thus, no data from any application will be mixed with data from other applications. Each application also is associated with a given security clearance level. For example, an application may be associated with either an unclassified, secret, secret-compartmentalized, top secret, or civilian-confidential security level. The security level indicates a classification of the application dictating who or what may have authorization to use the application or to see data from the application.

Each application may also be associated with a separate enclave, which defines a community of people who may use the application. Each enclave only allows access to authorized users. Thus, each partition of the memory may be associated with an enclave, and may only allow access to authorized users.

Each graphics application in the memory 102 outputs data to the video queue/guard 104 which implements a security routing policy to govern the acceptance and distribution of data from secure channels 112, 114 and 116. The function of the video queue/guard 104 is to receive data from each application (e.g., from each graphics source partition in the memory 102) and route the data to an allowed destination, and not to allow inter-mixing or contamination of data during the transmission. The routing policy mechanism of the described system can support mathematical verification of the security separation.

The video queue/guard 104 will receive data from each application at a respective port. Because each application has a dedicated secure channel on which to transfer data to the video queue and guard 104, the security level of all data from each of the multiple applications is well defined and will not be mixed.

The secure channel is protected by the RTOS and/or by encryption. Each secure channel 112, 114 and 116 is connected to a specific port on the video queue/guard 104 can identify from which application data was received based on which port the data was received. In addition, the routing policy engine of the video queue/guard 104 can review received data and may identify a sub-category of the source based on information contained in the received data. In addition, applications may be designed to control their own display content (independent of the Page Manager) by including mode control data in their data streams. This may be convenient in that it allows the Page Manager to remain at a low security level (e.g. unclassified).

Some source applications, such as global information grid portal applications, may be MLS applications that output data segregated into multiple enclaves. These applications may utilize tags on output data to mark data as any of two or more security levels. The described video queue/guard 104 can handle this without structural change by adding routing policy checks based on data packet headers or other tagging mechanisms. The security manager or a separate security manager would interact with such MLS applications to authorize secure operation.

In accordance with its security routing policy the video queue/guard 104 then sends received data to appropriate graphics render engines. During initialization of the system 100, a user may log into a specific enclave, and thus, may have access to a limited amount of data. Each enclave is associated with a user-community that indicates what that community is authorized to see. As a result, during a log in procedure, each graphics render engine 106, 108 and 110 is initialized as an application authorized (or capable of) receiving data at a given security clearance level. Other software and hardware interlocks as would be apparent to those of ordinary skill in the art may be included to ensure that even in the presence of a system fault, the output cannot be directed to an unauthorized destination.

Each graphics render engine 106, 108 and 110 outputs to a hardware output channel dedicated to the respective display 118, 120 and 122. Each display 118, 120 and 122 may include a separate terminal and/or user input device enabling a user to log into the system 100. In other embodiments, a multiplicity of display may receive a single output. During log-in, a user will initialize a given graphics render engine that outputs only to the display of the terminal that the user is operating. Based on the user's authorizations, the user will log-in and initialize the graphics render engine 106 108 or 122 to be authorized to receive data having the user's security clearance level so that only such data can be output to the display/terminal that the user is operating.

The system 100 may present a graphical user interface (GUI) on the display device 118, 120 and 122 on which a user may log into the system 100. The graphical user interface (GUI) may be of a standard type of user interface allowing a user to interact with the system 100 that employs graphical images in addition to text to represent information and actions available to the user. Actions may be performed through direct manipulation of graphical elements, which include windows, buttons, menus, onscreen cursors, and scroll bars, for example.

In addition, during the initialization of the graphics render engines, the routing policy engine 104 will receive a notification of the authorization level for each graphics render engine 106, 108 and 110. Thus, the routing policy engine 104 will then be able to send received data that has been identified as having a given security clearance level to a graphics render engine that has been authorized to receive data having the given security clearance level. For example, suppose a user logs into the display 118 at a security clearance level of SECRET. The graphics render engine 106 will then be initialized to operate at security clearance level of SECRET, and an indication of the initialization will be sent to the video queue/guard 104. Upon receiving data that has a security clearance level of SECRET, the video queue/guard 104 will send the SECRET data along with other authorized data, e.g. UNCLASSIFIED data, to the graphics render engine 106, which will display images of the data on the display 118.

As mentioned, each graphics render engine 106, 108, and 110 will be authorized to receive data having a certain security clearance level. In one instance, the graphics render engine 106, 108, and 110 will only be authorized to receive data that has the matching security clearance level to that at which the graphics render engine was initialized. In other examples, the graphics render engine 106, 108, and 110 may receive data that has that security clearance level, or lower. For example, if a graphics render engine was initialized to a security clearance level of SECRET, the graphics render engine may also receive data having a lower security clearance level, such as unclassified as well as SECRET data. In another example, if a graphics render engine is authorized to receive data that has a security clearance level TOP-SECRET (i.e., the highest security level), then the graphics render engine may be able to receive all types of data (except certain compartmentalized data that requires a different authorization). Table 1 below illustrates an example hierarchy of security clearance levels or data classifications. Compartmentalized data is restricted to a subset of the users within that compartmentalized project enclave. Other classification schemes can be supported.

TABLE 1

| | | | |
|---|---|---|---|
| 1. Unclassified | | | |
| 2. Confidential | | | |
| 3. Secret | 3. Secret-Compartment A | 3. Secret-Compartment B | . . . |
| 4. Top-Secret | 3. Top-Secret Compartment A | 4. Top-Secret-Compartment B | . . . |

In one example, a graphics render engine may be authorized to receive data that has a security clearance level matching that of the graphics render engine or lower. The graphics render engine 106, 108 and 110 will receive multiple streams of data (having the same or lower security clearance level to which the graphics render engine has been initialized), and will merge the data to be rendered on a display as specified in an internal display list used by graphics render engine application.

The graphics render engines 106, 108 and 110 will ignore any data that does not match the associated security clearance level which the graphics render engine has been authorized to receive. The graphics render engines 106, 108 and 110 will receive the data and, using a display list set at compile time, will construct an output using only data authorized by its display list. If the queue/guard would transmit unauthorized data to the partition, the data would not be drawn because the display list does not reference unauthorized data, for example.

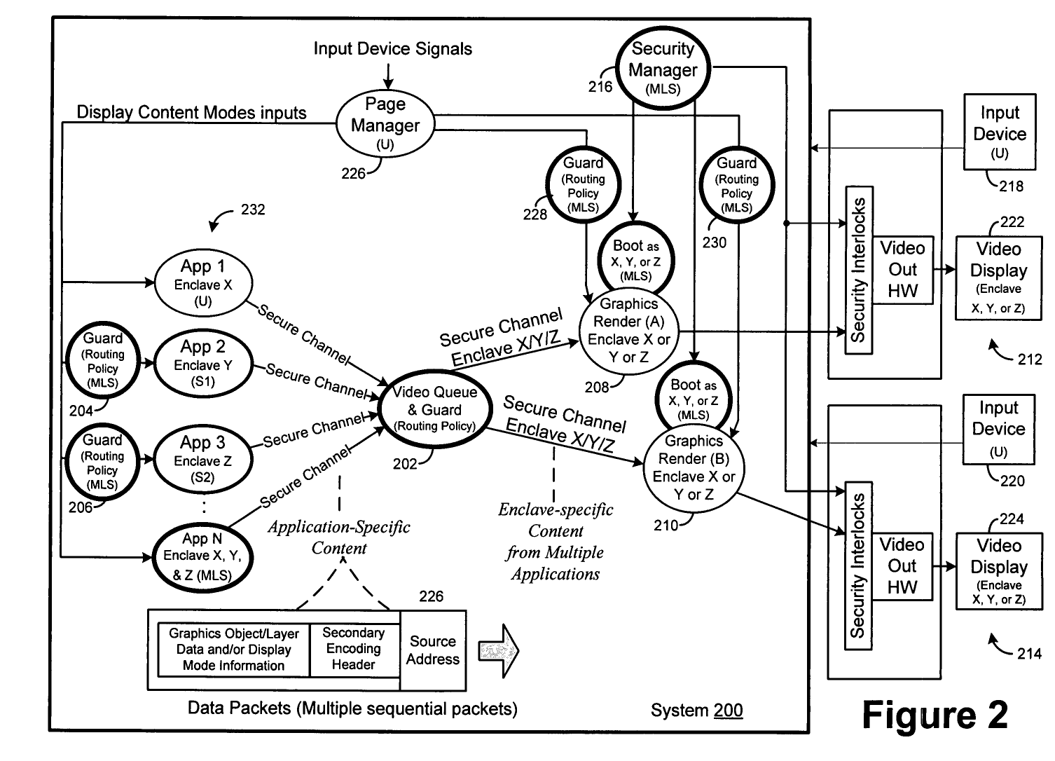

FIG. 2 illustrates another embodiment of a system 200 for providing secure video processing. The system 200 includes applications 1 to N, each stored and executed in a separate partition (not shown). Each application is associated with a respective security level as well. In some embodiments, functions of the applications may be duplicated in multiple partitions in order to perform the same type of processing on data at multiple security levels, e.g. creating a map overlay of unclassified navigation objects and of classified navigation points.

Each application generates graphical symbols using a graphics language interface defined by the Graphics Render applications 208 and 210 transmitted via secure channels through the video queue/guard 202. Data representing images in a single display layer is bundled into a packet 226 by the application. If required by the system security policy, the graphics language interface may be extended so as to not require backwards communication to the application from the video queue & guard 202.

Additional guard functions 204 and 206 may be provided for applications that have a high security clearance classification, such as applications 2 and 3 to prevent the Page Manager or other low security application from receiving any communication from these applications.

The applications process data with different security clearance levels. The applications transmit GL packets (objects) 226 through respective security-protected communication ports to the video queue & guard 202. The video queue & guard 202 directs the data to pre-assigned memory areas in each authorized graphics render applications as defined by the security policy restrictions built into the guard's routing policy.

For example, the video queue & guard 202 (also referred to as the routing policy engine in FIG. 1) receives graphics language (e.g., Open GL) data streams from multiple applications in multiple partitions and security enclaves. Each stream includes data packets 226 that each contain data that are to be treated as a unit for rendering purposes. The video queue/guard function 202 ensures software that communicates with the guard 202 does not receive data in violation of the system's security policy. The acceptance of data and setting a destination for the data is controlled by the video queue/guard 202 and is not influenced by either the applications.

The guard 202 functions are verified through extensive testing because the guard 202 is an MLS function with access to multiple enclaves and has the capacity to allow data to be misdirected if it contains defective software.

The guard 202 will receive data from the applications and determine a security clearance level of the data. The guard 202 primarily uses a port identifier of source input that is pre-assigned to a particular application and has a defined security level and a defined security policy rule set. The guard 202 may also refer to headers within data packets of the data to determine the security clearance level of the data, such as a secondary encoding header as shown in FIG. 2. If the source application is an MILS application, such encoding may be the primary routing criteria and would be trusted.

Subsequently, the guard 202 sends the data to a graphics render engine, such as graphics render engine 208 or 210, which has been given the same security clearance level as the data identified within the guard 202 routing policy. During a boot-up of terminals 212 and 214, an enclave security manager 216 will initialize each of the graphics render engines 208 and 210 according to a security clearance level of the user for each terminal 212 and 214 respectively. The terminals 212 and 214 include user input devices 218 and 220 allowing a user to log into a terminal and boot-up the terminal. The terminals 212 and 214 also include other video output hardware and security interlocks for receiving and outputting data. During boot-up, or initialization, the terminals 212 and 214 may boot up to a default security clearance level, and after a user logs-in, the terminals 212 and 214 may then be authorized to receive data that has classifications up to that at which the user is authorized.

Thus, after booting up a terminal, the graphics render engines 208 and 210 can be initialized to a security clearance level of X, Y or Z depending on the user's authorized use of the system 200. The graphics render engines 208 and 210 will then only receive data that has the security clearance levels they are authorized to receive by the guard 202 routing policy. The graphics render engines 208 and 210 will render the appropriate data (as stored in a memory location) to an appropriate display 222 and 224 in a desired order.

In this example, the graphics render engines 208 and 210 may use pre-defined enable/disable instructions received from its own secure boot process to respond to page selections and other mode commands from the page manager 226 via additional guard functions 228 and 230. Alternatively, or in addition, the graphics render engines 208 and 210 may be designed to respond to mode commands received from the source applications 232 as part of their video data streams. The graphics render engines 208 and 210 will construct an image in a video buffer using a display list provided by its own boot up process that defines the order in which enabled GL objects are to be drawn.

A display list controls what contents of the data are to be displayed in a given frame and in what order. The render engine display lists may be manually constructed for each security enclave or may be derived by a development tool from a master display list maintained by the designer. The tool filters the master display lists to create a consistent set for each enclave that is needed. The display lists allow data to be either fixed as “enabled” or fixed as “disabled” (if not ever used for a particular implementation) or may be controlled by an enable variable supplied by the security manager 216 or page manager 226 or by the source applications 232 to control what is rendered within the limits imposed by the system security policy.

Within the system 200, each guard function follows a separate set of rules, for example, as maintained in an internal table. The guard functions in the system 200 will block data that does not have an appropriate security clearance level classification as defined and set within the guard. Each guard function may pertain to a specific type of data. For example, the video queue and guard function 202 filters and blocks graphics data received from the applications. Other guards may be for other types of data, such as guards 204, 206, 228 and 230 that pass instructions informing the graphics render engines 208 and 210 of what page to draw, e.g. navigation database pages, digital maps, radio control pages) as well as pass instructions informing the applications to operate in the proper mode and display the proper content.

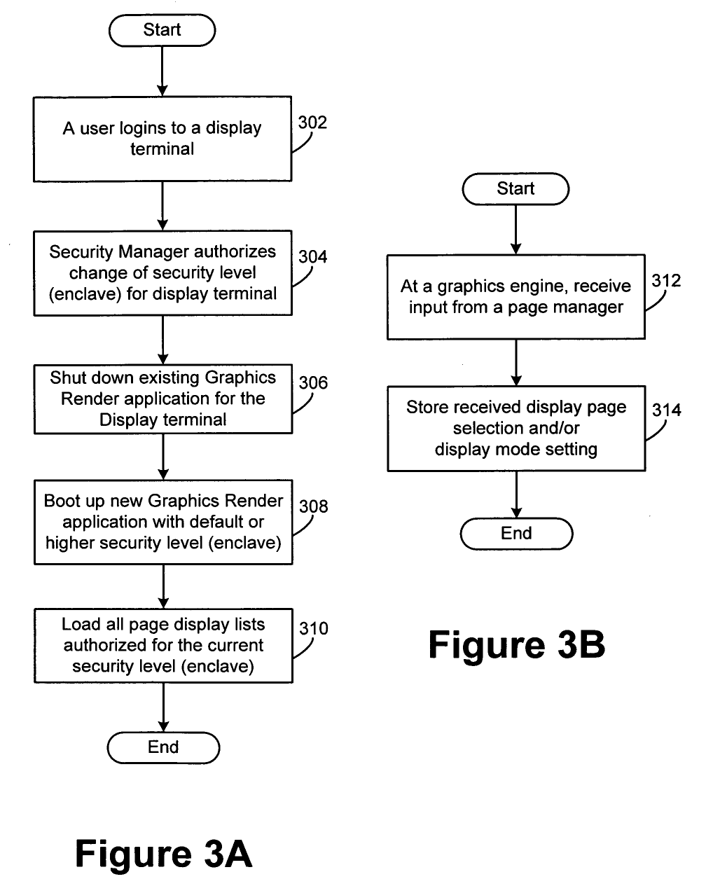

FIGS. 3-5 are flowcharts including functional steps for providing secure video processing. It should be understood that the flowchart only shows the functionality and operation of a possible implementation of the present embodiments. In this regard, each block may represent a module, a segment, or a portion of program code, which includes one or more executable instructions for implementing specific logical functions or steps in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art of the present invention. Alternative paths for page control settings and alternative mechanizations of the security policy are supportable.

FIG. 3A illustrates a flowchart of operations occurring by the security manager (as described in FIGS. 1-2). As shown at block 302, initially, a user will login to a display terminal. Subsequently, as shown at block 304, a security manager uses any of various login methods to authorize an initial or modified security level for a particular display terminal according to the user's authorization clearance. For example, the security manager can refer to a user profile database to identify the user's authorization clearance. Next, as shown in block 306, a secure boot process for the specific display terminal at which the user logged-in shuts down and cleanses the current graphics render partition function. As shown in block 308, next the secure boot process boots or reboots a version of the graphics render application appropriate to the new security enclave. As shown in block 310, a set of page lists (page templates) for each display page that can be selected by the established enclave is loaded. In other embodiments, different display list mechanisms may be used. At this point, the graphics render software is ready to operate.

FIG. 3B illustrates a flowchart of functions performed by a graphics engine. As shown at block 312, initially a graphics engine will receive an input from a page manager with instructions for display pages. Subsequently, as shown at block 314, the graphics engine will store the display page selection and/or display mode setting. Thus, the receipt of control data, such as page selection or display mode settings, that are provided as part of the page management function and not associated with a particular graphics source application are made at a graphics engine. The page management function itself may be embodied as a particular software function or it may be embodied in a distributed manner by a number of loosely coupled functions.

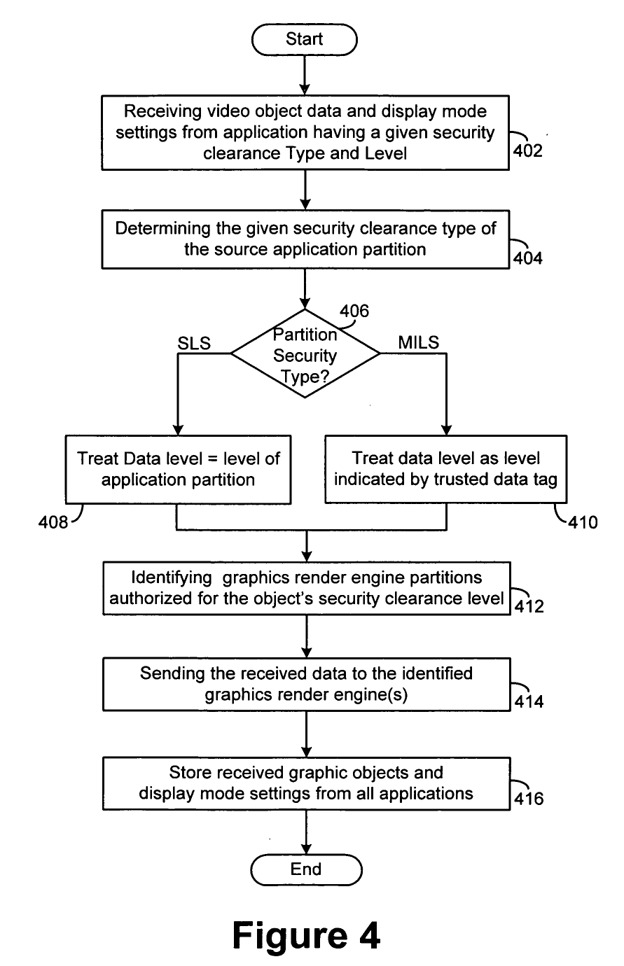

FIG. 4 is a flowchart illustrating functions performed by the video queue/guard. Initially, as shown at block 402, the video queue/guard receives data from any of the installed graphics applications. The nature of the application functionality is incidental to the secure data processing and can include any combination of applications that may include any number of single level of security (SLS) applications in one or more partitions, or multiple levels of security (MLS) applications each in a single partition. The applications may be located in the same processor, card, hardware chassis or not. The applications may communicate directly through shared memory, through parallel or serial hardware bus interfaces, through network media including radio frequency or other datalink means. Other applications not directly involved in the graphics creation may co-exist in the system.

As shown at blocks 404 and 406, the video queue/guard determines a given security clearance TYPE of the source application, such as either an SLS or MLS source application. SLS application data can be detected and the security routing policy implemented using only the identity of a secure input port ID provided by the MILS RTOS and used in the video queue/guard to receive data. As shown in block 408, if the partition is an SLS partition, received data is treated as having a security level equal to the security level that is assigned to the SLS partition of the source application. On the other hand, if the partition is an MLS partition, as shown at block 410, where multiple levels of secure data are obtained from a single MLS data input, the security level of the received data is embedded by any desired method as indicated in the data stream. For example, a data tag or other identifying data used to assign a proper security level to each piece of graphical object data.

For both the SLS and MLS case, once the security level is assigned, the video queue/guard consults predefined security policy rules, and as shown at block 412, identifies all graphics render engines that are to receive each piece of received data. As shown in block 414, the data is then transferred to each graphics render engine that is authorized to receive the data. The output of the video queue/guard next merges the data into a single data stream, but the order in the data stream does not determine an order in which graphic objects will be merged in the image to be created. As shown at block 416, data is received at a graphics render engine and stored in a temporary memory location. Storage may be in many forms, such as static memory mapped data lists, dynamic data structures, real time databases, and other embodiments that meet a desired video frame refresh rate.

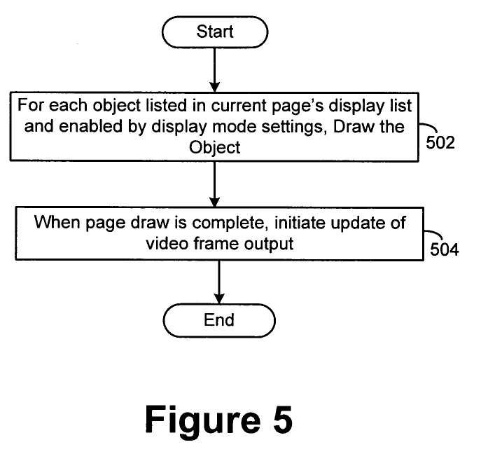

Functions associated with a rendering process for each active display terminal are described in the flowchart illustrated in FIG. 5. As shown at block 502, a display list corresponding to a currently selected display page is used to render each object into memory in the proper order, and rendering includes converting the GL instructions into pixels in the video frame buffer. However, other methods may be used as well. Many independent objects are drawn in such a way that to the eye of the observer the objects merge (statically and as the objects move over time) in a way that conforms to expectations of the human observer. To do so, objects are made to appear like entities that interact like real objects when the object overlay. For example, objects cannot occupy the same space at the same time and appear to differ in a distance from the observer. One method to do so is to order objects in the display list so that the objects are drawn in an order from the bottom-most to the top-most object to assure a desired visual behavior of overlapping objects.

Alternative display list techniques are available that use zone masking, z-buffer occlusion, etc., to achieve a desired behavior. Suitable techniques exist for both 2D and 3D imagery formats and are supported. Using fixed display lists with display mode settings to enable/disable and potentially to change the apparent order of objects achieves a desired appearance and consistency over time. During the process, display mode settings received are used to enable or disable specific symbology to put each object in a correct stacking order (layer). To achieve full control of object interaction, the graphics language (GL) data from source applications for each object is designed to be self-contained so as to allow the draw order to be changed for individual objects without corrupting the appearance of that or other graphic objects. As mentioned, rendering includes converting the GL instructions into pixels in the video frame buffer, but other methods could be used. Vector object and other rendering techniques can be supported by this secure data processing method. Once the entire display page content is rendered, as shown at block 504, software and hardware means are used to begin using the new frame image in the video stream going to the display. The process may have further security and other interlocks to inhibit or modify the output as desired. The output format is incidental and may be analog video, digital video, network streaming video, steaming multi-media format, or other formats.

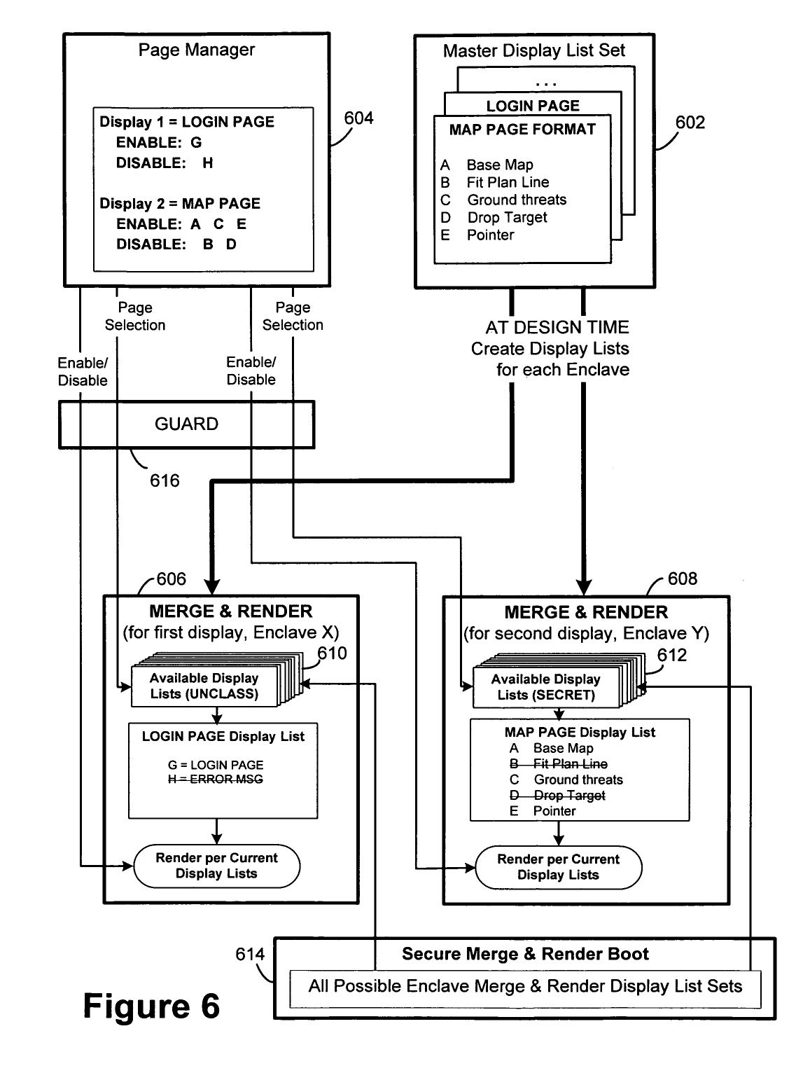

FIG. 6 illustrates a conceptual diagram showing one example of page display list formatting and communicating page display lists between elements of the system.

Initially, during software design, individual display lists for each page that can be displayed are created. A separate display list set is created for each security level enclave and if desired for each display/terminal. For convenience, a master display list set 602 can used to create the display list set for each enclave by a process of manual or automatic filtering. When each Merge and Render 606, 608 software function is compiled, the appropriate display lists 610, 612 respectively are embedded in the software for each merge and render function according to its security level.

Subsequently, the appropriate Display List set 610, 612 is loaded by the boot software 614 that initializes the Merge and Render 610, 612 software for each display to its security level by providing the appropriate display list set.

When objects are to be rendered, a page manager 604 (also described in FIGS. 1-2) will send instructions to the merge and render functions 606, 608 indicating which display list to use, and then enabling/disabling the display of the objects contained in the selected display list. The page manager controls the screen format selection, not content of the screen. Instructions are passed between the page manager 604 and the merge and render functions 606, 608 through a guard 616 that prohibits data from escaping from the merge and render software. In the conceptual diagram illustrated in FIG. 6, the master display list may be stored in a separate storage or within the system and accessible by the page manager as well as allowed by the security requirements.

Secure video processing may be needed in a wide variety of applications. One such application is for a moving map display application. As an example, several applications may work together to create a half-screen map page including a base map, geographical overlays, and screen-oriented symbology lying on top of the map while a separate application generates a half-screen non-map page beside the map while yet another application draw a user-interactive floating window on top of both half screen pages.

Using the described embodiments, data may be output to displays using one system in a manner such that separation of data is maintained. This is an improvement over past solutions where multiple processors with custom designed software and in some cases multiple displays were needed to display different types or security clearance levels of data. Although the description above has focused on data being output onto a display, in other embodiments, the data may be output in other forms such as audio or radio or mechanical.

It should be understood that the arrangements described herein are for purposes of example only. As such, those skilled in the art will appreciate that other arrangements and other logic or circuit elements can be used instead, and some elements may be omitted altogether according to the desired results. Further, many of the elements that are described are functional entities that may be implemented as discrete or distributed components or in conjunction with other components, in any suitable combination and location.

It is intended that the foregoing detailed description be regarded as illustrative rather than limiting, and it is intended to be understood that the following claims including all equivalents define the scope of the invention.

What is claimed is:

1. A system comprising:
memory including partitions, wherein each partition has an associated security clearance level such that the partition only stores applications having the associated security clearance level;
a plurality of graphics engines for receiving data from applications and rendering an image based on the data onto a display, wherein during initiation of the graphics engines, each graphics engine is authorized to only receive data having given security clearance levels, and wherein the graphics engine will not process data not having the given security clearance levels or lower security clearance levels; and
a guard routing policy engine for receiving data from each application via respective secure channels and identifying a security clearance level of the data, the guard routing policy engine further for sending the data via respective secure channels to only graphics engines authorized to receive data having the identified security clearance level.

2. The system of claim 1, wherein the guard routing policy engine maintains separation of received data.

3. The system of claim 1, wherein a user identifies the user during initiation of the system and sets the given security clearance levels of the plurality of graphics engines to be authorized to receive data having the given security clearance levels.

4. The system of claim 1, wherein the guard routing policy engine identifies a security clearance level of the data by reviewing header information of data packets.

5. The system of claim 1, wherein the guard routing policy engine identifies a security clearance level of the data by identifying an incoming port of the data.

6. The system of claim 1, wherein the guard routing policy engine further includes a table indicating security clearance levels of each graphic engine, and wherein the guard routing policy engine sends the data via the respective secure channels to the graphics engines by referencing the table to identify which graphics engines are to be sent the data.

7. The system of claim 1, wherein during initiation of the graphics engines, the plurality of graphics engines are authorized to receive data having an unclassified security clearance level.

8. The system of claim 7, wherein a user identifies the user during initiation of the system and sets the given security clearance level of the plurality of graphics engines to be authorized to receive data having a higher security clearance level.

9. The system of claim 1, further comprising a display for displaying data rendered by the plurality of graphics engines.

10. The system of claim 9, wherein a graphics engine will render images according to the data such that a rendering order is by graphical object or graphical object group and independent of a security clearance level or source of the data.

11. The system of claim 9, wherein a graphics engine will render data by referencing a table that indicates a rendering order for types of data.

12. A method comprising:
initiating a system including a plurality of graphics engines to given security clearance levels, wherein each graphics engine is authorized to only receive data having the given security clearance levels, and wherein the graphics engine will not process data not having the given security clearance level; and
receiving data at a guard routing policy engine from applications via separate channels for each respective application;
identifying a security clearance level of received data;
sending the data via respective secure channels to a graphics engine authorized to receive data having the identified security clearance level; and
the graphics engine rendering an image based on the data from a plurality of sources on a display.

13. The method of claim 12, further comprising storing the applications in respective partitions of memory, wherein each partition in the memory has an associated security clearance level such that the partition only stores applications that use data having the associated security clearance level.

14. The method of claim 12, further comprising during initiation of the graphics engine, a user authorizing the graphics engine to receive data having a given security clearance.

15. The method of claim 12, wherein identifying the security clearance level of received data comprises reviewing header information of data packets in the data.

16. The method of claim 12, wherein identifying the security clearance level of received data comprises identifying an incoming port of the data.

17. The method of claim 12, wherein the guard routing policy engine further includes a table indicating security clearance levels of each graphic engine, and wherein the method further comprises referencing the table to identify which graphics engine to send the data.

18. The method of claim 12, further comprising rendering images according to the data such that a rendering order is by graphical object or graphical object group and independent of a security clearance level or source.

19. The method of claim 18, wherein a graphics engine will render data by referencing a table that indicates a rendering order for types of data.

20. The method of claim 12, further comprising the graphics engine determining a security clearance level of received data and ignoring data not having a security clearance level the same as or lower than a security clearance level at which the graphics engine has been initialized.
